(19) United States
(12) Patent Application Publication
(10) Pub. No.: US 2012/0173633 A1
(43) Pub. Date: Jul. 5, 2012

(54) EMAIL CONVERSATION MANAGEMENT SUPPORT

(75) Inventors: VENKATUDAY M. BALABHADRAPATRUNI, SAN JOSE, CA (US); STEVEN MA, SAN JOSE, CA (US)

(73) Assignee: INTERNATIONAL BUSINESS MACHINES CORPORATION, ARMONK, NY (US)

(21) Appl. No.: 12/981,273

(22) Filed: Dec. 29, 2010

(51) Int. Cl. G06F 15/16

(52) U.S. Cl. 709/206

(57) ABSTRACT

An embodiment of the disclosure alleviates organizational and management issues with email conversations by providing email conversation management support tools. These tools provide a conversation originator (or other administrator) an ability to perform management actions for an email conversation. These actions can include, for example, an ability to explicitly end an email conversation so that no further messages in the conversation can be sent. A corresponding ability to re-open previously closed or ended email conversations can also be provided. Further, functionality to summarize an email conversation, to establish a priority or importance level for email conversations, to annotate email conversations, and/or to annotate and prioritize individual messages of an email conversation can be provided. In one embodiment, an email conversation administrator can be responsive for creating annotations, opening, and closing email conversations.

### BACKGROUND

The present invention relates to the field of email and, more particularly, to inviting temporary participants to a system, method, computer program product, and/or apparatus for providing email conversation management support.

Email conversations, also referred to as email threads, can include a sequence of responses to an initial email message. In an email conversation, a set of users who receive an initial message often respond back and forth using a reply or a reply all option. The original sender (and other recipients) can respond back using a reply or a reply all option, and so forth. Sometimes, new participants can join an email conversation, after they receive a forwarded message from one of the participants. Email conversations can be provided with or without history, where the history shows the sequence of responses in a chain of responses, which may include all email messages between a current one all the way back to the initial email message. Email conversations can extend over a significant time and can include any number of messages. Conventionally, email conversations are ad-hoc sequences of messages, which are not managed (or that are minimally managed) by any system tools, other than potentially grouping messages by email conversation.

### BRIEF SUMMARY

One aspect of the disclosure can include a method, computer program product, apparatus, and system. In this aspect, a state for an email conversation can be established within an email server. The email conversation can include a sequence of zero or more response email messages to an initial email message as well as the initial email message. The state of the email conversation is able to be changed between open and closed. If the state of the email conversation is in an open state, new response email messages are allowed to be created from a user interface of an email application for the email conversation. The new response email messages are conveyed by the email server to a set of recipients indicated within each of the new response email messages. If the state of the email conversation is in a closed state, users are prevented from creating new response email messages for the email conversation. The preventing ensures that new response email messages for the email conversation are not conveyed by the email server to any recipient.

In one embodiment, a set of time stamped annotations can be established for the email conversation and for specific messages of the email conversation. In response to a user of the user interface selecting one of the email messages via a hover event of a GUI pointer being triggered, the time-stamped annotations associated with that email message and the email conversation can be dynamically and automatically presented in a fly-over window of the user interface.

One aspect of the disclosure can include a method, computer program product, apparatus, and system. In this aspect, a conversation support component able to change a state of an email conversation. The email conversation can include a sequence of zero or more response email messages to an initial email message as well as the initial email message. The state of the email conversation is able to be changed between open and closed. If the email conversation is in an open state, participants of the email conversation are able to provide new email responses to email messages of the email conversation. If the email conversation is in a closed state, participants of the email conversation are not permitted to provide new email responses to email messages of the email conversation.

One aspect of the disclosure can include a method, computer program product, apparatus, and system. In this aspect, a conversation support component is able to provide a plurality of email conversation management functions. A data store of an email server can include a set of email messages managed by an email server. The data store can index email conversations to the email messages. Each of the email conversations can include a set of data elements directly associated with a specific one of the email conversation and not directly associated with any specific email message. At least one of the data elements can be an urgency level for the email conversation. The urgency level can indicates one of a set of different discrete values, each indicative of a different level of urgency for the email conversation. At least one of the data elements can indicate a user identity of an administrator of the corresponding email conversation. The administrator can be the only user permitted to change values of the data elements of the corresponding email conversation, which other participants of the email conversation are able to view but are unable to change.

### BRIEF DESCRIPTION OF THE SEVERAL VIEWS OF THE DRAWINGS

FIG. 1 is a diagram for providing management support for an email conversation (e.g., email thread) in accordance with an embodiment of the disclosure.

FIG. 2 shows a system in which conversation support processing is implemented in accordance with an embodiment of the disclosure.

FIG. 3 shows a set of user interfaces for support information for email conversations in accordance with an embodiment of the disclosure.

FIG. 4 is a flow chart of a method for managing email conversations in accordance with an embodiment of the disclosure.

### DETAILED DESCRIPTION

When users participate in a large number of email conversations, these communications can become cumbersome. That is, the ad-hoc nature of an email conversation (e.g., a series of “reply-all” messages, for example) can be both an advantage at a disadvantage. The disadvantages include that over time, it can become difficult to track the outcome of an email conversation, related action items, and a conversation status. That is, different email conversation recipients may assume that discussed problems and/or situations have been handled by others, yet no action was in fact taken. Further, multiple different users participating in an email conversation may redundantly take actions, which should have been more coordinated or have been taken by a single individual. Problems associated with the ad-hoc nature of email conversations exacerbates as time lapses.

The present disclosure alleviates organizational and management issues with email conversations by providing email conversation management support tools. These tools provide a conversation originator (or other administrator) an ability to perform management actions for an email conversation. These actions can include, for example, an ability to explicitly end an email conversation so that no further messages in the conversation can be sent. A corresponding ability to re-open previously closed or ended email conversations can also be provided. Further, functionality to summarize an email conversation, to establish a priority or importance level for email conversations, to annotate email conversations, and/or to annotate and prioritize individual messages of an email conversation can be provided. In one embodiment, an email conversation administrator can be responsive for creating annotations, opening, and closing email conversations. Email participants involved in the communication can view these annotations and conversation status indicators. In one embodiment, the conversation support information and functionality can be integrated with email front-end applications and/or back-end systems.

Through use of the conversation support information disclosed herein, recipients can receive real-time updates on the status of the email conversation, regardless of that recipient's understanding of conversation specifics (from previous email messages in the email conversation) that have already taken place. Further, email recipients can quickly learn the latest status of the email conversation without having to read every single email message in the conversation. The disclosure can give a conversation administrator (which can be an originator by default) an ability to control a life cycle of the email conversation once email has been sent. That is, the administrator can explicitly change the conversation's state (e.g., open or closed) and can change a current urgency level (e.g., low, medium, high). Embodiments of the disclosure can result in improved email manageability, including an ability to delete or archive an entire email chain without having to select individual emails in the chain for activation/deactivation. In one embodiment, recipients (or participants in the email conversation) can annotate specific ones of the email messages with personal notes that only he or she can read (or that only a defined subset of the participants can read, such as the writer and conversation administrator/originator).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

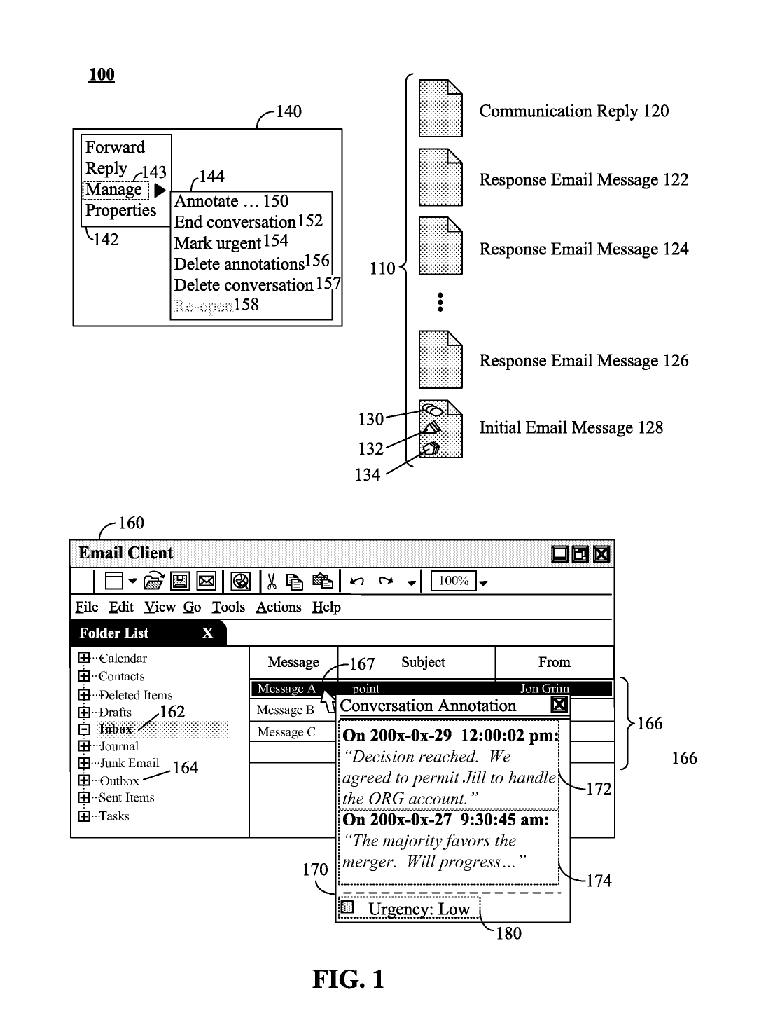

FIG. 1 is a diagram 100 for providing management support for an email conversation 110 (e.g., email thread) in accordance with an embodiment of the disclosure. In one embodiment, an email conversation (110) support menu 140 (or functional equivalent) can be integrated with an email application, represented by email client interface 160.

As used herein, the email conversation 110 can include an initial email message 128, and a set of zero or more response email messages 126, 124, 122. The response email messages 122-126 can be responses to the initial message 128 or can be responses to other ones of the response email messages 122-126, at least one of which is a response to the initial email message 128. Communication reply 120 can represent the last message sent in the email conversation 110 or one about to be sent in response to another one of the email messages 122-128.

Each email message 120-128 can be a digital message able to be stored in a storage medium that is able to be conveyed across the internet or other computer network. Email messages can be facilitated by an email system based on a store-and forward model. That is, an email server can accept, forward, deliver, and store email messages conveyed to it by clients. In contemplated embodiments, email messages 120-128 can be carried over a network by a simple mail transfer protocol (SMTP), a file transfer protocol (FTP), or other protocol. In contemplated embodiments, client applications can use post office protocol (POP), the internet message access protocol (IMAP), various proprietary systems (e.g., LOTUS NOTES/DOMINO, MICROSOFT EXCHANGE, etc.), and the like to access mail box accounts maintained by an email server. In one embodiment, email messages 120-128 can conform to Multipurpose Internet Mail Extensions (MIME) based standards.

Each email message 120-128 can include zero or more attachments 130, email content 132, and a set of attributes 134, which are specific to that email message. The attachments 130 can be computer files that are sent along with an email message. Message content 132 can include content from the message body of a corresponding email message. The message content 132 can include plain text, HTML, formatted text, and/or media content. The attributes 134 can include information from a message header of a corresponding message, as well as metadata associated with the email and/or maintained by an email server. Attributes 134 can include, for example, from, subject, to, carbon copy, blind carbon copy, sent time, and other information.

Menu 140 shows a set of standard options 142 available for email messages, such as forward, reply, and properties. Additionally, one of the menu options 142 is an option 143 to manage the associated email message or email conversation 110. The annotations added via the management support 143 options can be presented when one of the email messages 120-128 is selected. For example, a message 167 shown in interface 160 can be selected, which results in a presentation of window 170.

The management option 143 can include a number of sub-options shown in submenu 144. These sub-options can include, but are not limited to, an annotate option 150, an end conversation option 152, a mark as urgent (or other priority level) option 154, a delete conversation annotation 156 option, a delete conversation option 157, a re-open conversation option 158, and/or the like.

Annotate 150 can content to an email message and/or a email conversation 110. In one embodiment, annotations can be automatically presented when a corresponding email message is selected. Each annotation can have a corresponding urgency 154 option, able to be used to establish an urgency level (e.g., high, medium, low). In one embodiment, annotations 150 that correspond to email messages 120-128 can have security settings enabled, which restricts viewing to the annotation creator, the annotation creator and the email conversation (110) administrator, and/or other set of defined email users.

Submenu 144 can include user selectable options for ending 152 an email conversation (110) and for re-opening 158 a previously closed email conversation (110). If an email conversation 110 is closed, an email server managing the conversation can prevent users from providing any further responses to the conversation 110. In one embodiment, a conversation 110 can be re-opened (option 158) by an authorized user, after which users are able to include new messages or responses within the conversation 110.

The closing of an email communication can be implemented in multiple contemplated ways. For example, a front-end interface (enhanced with conversation support) can indicate that the message is not able to be sent when a reply (120-126) to a closed email conversation 110 is attempted. In another embodiment, reply options (e.g., reply, reply all) can be disabled when the email conversation 110 of which a message is a member is closed. In another embodiment, an email server can provide a response message to an attempt to reply to a closed email conversation, which states that the reply has been refused and will not be sent, since the email conversation is closed. A further option may exist so that the communicator can contact an email conversation administrator and request the message be sent anyways and/or the email conversation (110) be re-opened (e.g., per option 158).

Submenu 144 can include a delete annotation(s) option 156 as well as a delete conversation option 157. Selection of the delete annotation option 156 can remove any support information (e.g., annotation added via option 150) added to an email conversation, while not otherwise affecting the messages (120, 122, 124, 126, 128) of the conversation 110. Selection of the delete conversation option 157 can delete not only the annotations (and other support information) associated with an email conversation 110, but also the messages of 120, 122, 124, 126, 128 of the conversation 110. Additional options can be established for deleting specific sets of one or more annotations.

Options shown in submenu 144 are not intended to be comprehensive and other conversation management actions are contemplated. For example, in one embodiment, an archive conversation option and/or archive annotations option can be implemented. In another embodiment, an option to convert an annotation to an attachment can exist. In one embodiment, an option to show/hide personal annotations to/from an administrator of the email conversation 110 can be included in submenu 144.

In one embodiment, a flyover window 170 can be presented when a graphical user interface (GUI) pointer hovers over an email message 167 for a designated period of time. In one embodiment, the flyover window 170 can show a time stamp and a user provided comment for each annotation 172, 174. A set of one or more annotations 172, 174 can be shown along with an associated urgency level 180. Additional or alternative support information for the email conversation 110 or selected email message 167 (of the set 166 of messages) can be included in the flyover window 170. A flyover window 170 is just one contemplated GUI mechanism for displaying the email support information; other mechanisms are contemplated. In one embodiment the support menu 140 and flyover window 170 can be integrated with an email client interface 160 having an inbox 162, outbox 164, and other such components.

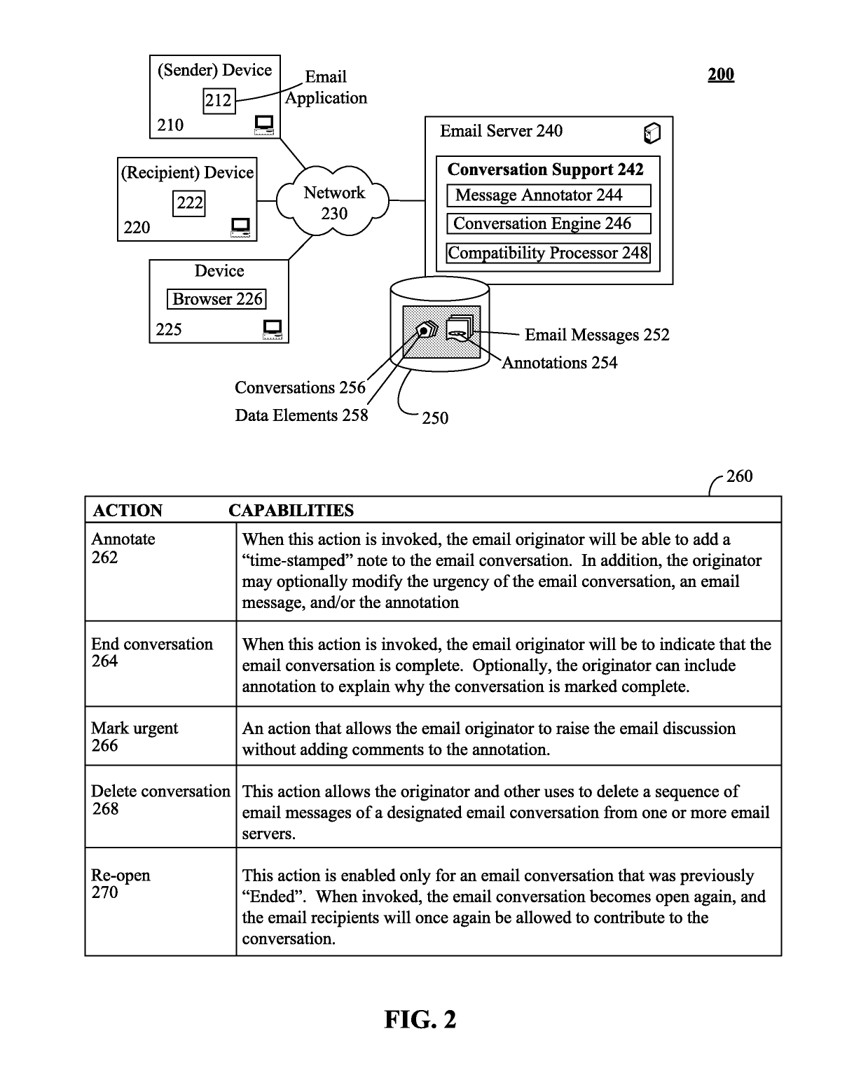

FIG. 2 shows a system 200 in which conversation support processing 242 is implemented in accordance with an embodiment of the disclosure. In one embodiment, the specifics of FIG. 1 can be implemented using the system 200. In system 200, a set of computing devices 210, 220, 225 can be connected to a network 230 to which an email server 240 is also connected.

Each computing device 210, 220, 225, and server 240 can include at least one processor, circuitry, storage medium, peripheral, network interface, and/or other components; all communicatively linked to each other via a bus. The processor of each device 210, 220, 225, and 240 can execute computer readable instructions. Devices 210, 220 can include client-side software (email application 212, 222) for interacting with email server 240. Client 225 can include a Web browser 226, which can interface with a Web server. Server 240 can include a conversation support processing engine 242.

Each computing devices 210, 220, 225 can be a personal computer, a notebook computer, a netbook, a kiosk, a mobile phone, and the like. The email server 240 can be a stand-alone computing device, a distributed set of computing devices, and/or a virtual server implemented using virtualization software.

Email server 240 can store and manage email messages 252, where the storage of messages can occur in data store 250. Data store 250 can index the email messages 252 by email conversation 256. Email messages 252 can also include annotations 254, which can be personal annotations, annotations viewable only by an author and a conversation administrator, and/or annotations viewable by any defined set of conversation participants. Data elements 258 can include datum defined at an email conversation level of granularity. The data elements 258 include annotations, a conversation state (open or ended), an urgency level of the conversation, conversation summary information, purpose information, and the like.

The conversation support processing component 242 can include code for a number of support actions and events, such as those expressed in table 260. That is, conversation support processing component 242 can permit system 200 to perform annotation actions 262, end-conversation actions 264, an urgency level actions 266, delete conversation actions 268, re-open conversation actions 270, and the like. In one embodiment, each of these actions 262-270 can be triggered by an end user from email application 212 or 222.

Action 262 can be to annotate an email message, a group of email messages, and/or an email conversation. The creation and/or editing of annotations can be restricted to an email conversation administrator in one embodiment. In another embodiment, creators of each email message of an email conversation can also be permitted to add or edit annotations for the messages that the email creator sent. In one embodiment, invocation of action 262 can cause the email originator (or other appointed administrator) to add a time-stamped note to the email conversation. In one embodiment, the creator of the annotation can optionally modify the urgency level of the email conversation, an email message, and/or an annotation.

The end conversation action 264 can change a state of the email conversation to non-active, where no new email messages are able to be responded to during this email conversation. Invocation of action 264 can provide an option to explain why the email conversation was marked as complete.

The mark urgent action 266 is an action that allows an email originator (administrator or other authorized user) to change a priority level of an annotation, email message, or email conversation. For example, the email originator can use the action 266 to raise (or lower) the email conversation's importance level without adding other comments to the annotation (through action 266).

The delete conversation action 268 can be one that allows an email conversation administrator or other authorized user to delete a sequence or set of email messages from one or more email servers, clients, or other repositories. The deletion of the email messages can cause the associated email annotations to also be deleted. In one embodiment, deletion of the messages can occur in a manner that the deleted content is able to be recovered. Thus, the deletion through action 268 may or may not be implemented as an irrevocable or a revocable action depending on embodiment specific choices.

The re-open action 270 can cause a previously closed (or ended via action 264) email conversation to be re-opened. The re-open action 270 can be enabled only for an email conversation that was previously ended. When invoked 270 an email conversation can become open again. In one embodiment, action 270 can be used to selectively open the email conversation for a fixed duration, for a single (or N) number of responses, for a limited purpose, for a limited set of users, and the like. The actions 262-270 can be implemented within sub-engines 244-248 of component 242.

The message annotator engine 244 can, for example, be a component that creates specific annotations linked to specific email messages. In one embodiment, the content of the annotations can be included in metadata of the email messages themselves. For example, if an email message is stored in an XML format, an XML tag can be established for each annotation. In another embodiment, the annotations handled by engine 244 can be stored in a separate record or file from the email message. The annotations 254 may be stored by the email server 240 in one embodiment. In another embodiment, the annotations 254 can be stored in a remote repository and handled by a server (or Web service) remote from the email server 240 and data store 250.

The conversation engine 246 can be component that handles email conversation level data (e.g., data elements 258) and annotations. The conversations 256 and data elements 258 are able to be maintained and managed by email server 240 in one embodiment. In another, the conversation 256 and data elements 258 can be maintained by a server and data store remote from server 240 and data store 250. The conversation engine 246 can be used to start (action 264) and stop (action 270) email conversation actions.

The compatibility processor 248 can be a component used to implement the data elements 258, conversations 256 and other support information in a manner compatible with legacy systems. For example, the email server 240 can interface with one or more email servers or systems that are lack native support for annotations, email conversation management data, and conversation specific functionality. In one embodiment, for example, annotations 356, conversations 256, and data elements 258 can be written to attachments when being conveyed to clients that are not able to view annotations. In another embodiment, an email sent to a non-compatible (e.g., legacy) server 240 or client can be sent with a link to a Web site. The Web site can provide the annotations 254, conversation 256, and data elements 258 linked to the email message. Thus, a browser 226 can be used to access email conversation specific information, even when a utilized email application 212, 222 cannot.

The engines 244-248 are presented for illustrative purposes only and are not intended to be comprehensive. Instead, the engines 244-248 are intended to demonstrate that extensible capabilities based on a variety of criteria can be implemented for conversation support processing component 242.

Network 230 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 230 can include local components and data pathways necessary for communications to be exchanged among computing device components and between integrated device components and peripheral devices. The network 230 can also include network equipment, such as routers, data lines, hubs, and intermediary servers which together form a packet-based network, such as the Internet or an intranet. The network 230 can further include circuit-based communication components and mobile communication components, such as telephony switches, modems, cellular communication towers, and the like. The network 230 can include line based and/or wireless communication pathways.

Each device 210, 220, 225 and server 240 can include a data store, such as data store 250, which is physically implemented within any type of hardware including, but not limited to, a magnetic disk, an optical disk, a semiconductor memory, a digitally encoded plastic memory, a holographic memory, or any other recording medium. The data stores can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

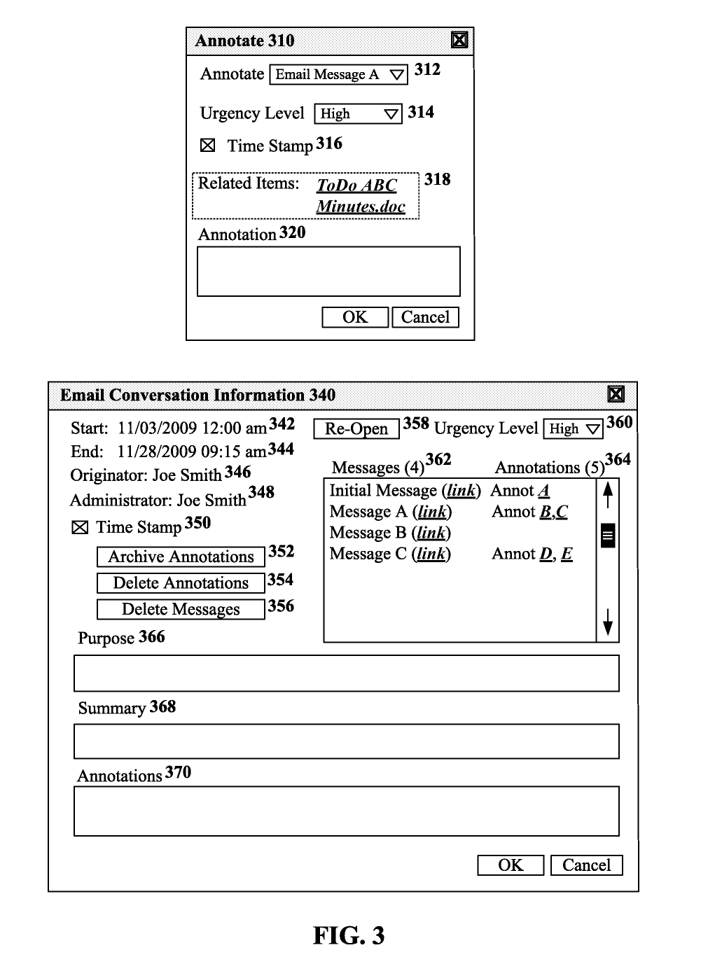

FIG. 3 shows a set of user interfaces 310, 340 for support information for email conversations in accordance with an embodiment of the disclosure. In one embodiment, the interfaces 310, 340 can be for system 200 and/or can be used in conjunction with diagram 100.

Annotate user interface 310 shows a window or annotation screen, which can be used to specify annotations for an email message or email conversation. In one embodiment, annotation interface 310 can be presented when an annotation option (option 140) is selected from a context menu (e.g., menu 144). Selection element 312 permits a user to specify an email message and/or an email conversation, to which the annotation message 320 entered in interface 310 applies. An urgency level 314 can be specified via the interface 310. Interface 310 can also have a time stamp 316 option, which determines whether or not a time stamp is to be automatically appended or otherwise associated with an annotation message 320. The related items section 318 can create linkages between the annotation message 320 and a set of items, such as a “to-do” item, a document, a Web site, and any other document or record that is not an email message or annotation. The annotation message 320 can include user specified text, media, video, audio, image, or any other type of file.

Email conversation information interface 340 represents a user interface through which support information for an email conversation can be viewed, edited, created, deleted, and the like. The interface 340 can be used by a same front-end application that utilizes interface 310. The interface 340 may also be part of a front end lacking interface 310 or its equivalent. Interface 340 may or may not be integrated directly with an email application front-end program depending on implementation choices. In one embodiment, the interface 340 can be a Web based interface, such as one accessible by device 225 via a browser 226.

More specifically, the email conversation interface 340 can present a number of email conversation specific data elements (such as elements 258) within a number of user interface fields (e.g., fields 342-255, 360, 366, 368, 370, and the like). The fields can indicate when the email conversation started 342, which can be the time an initial message (e.g., email message 128) was sent. The end time field 344 can be a time that the last email message of a conversation was sent and/or the time that an action to end a conversation (e.g., option 152, action 264) was performed. If the conversation is currently in an ended state (field 344), then an option to re-open 358 the email conversation can be active (i.e., re-open option 358 can trigger the re-open action 270).

Interface 340 can show an originator 346 and an administrator 348 of the email conversation. In one embodiment, the administrator 348 can be defaulted to the originator 346 and/or can be someone appointed as administrator by the originator 346 (or other person having supervisory authority of the email conversation). User interface 340 can include a capability to time stamp 350 changes made via interface 340 and/or annotations, such as annotation 370. Urgency level 360 can be established for the email conversation, which may or may not be different from the urgency level 360 of messages and/or annotations of the email conversation.

The interface 340 can permit a user to specify a purpose 366, summary 368, and zero or more annotations 370 for the email conversation. Each 366, 368, 370 can permit text input, video input, audio input, graphical input, and the like.

In one embodiment, the various email messages 362 of the email conversation can be shown in the interface 340 along with a link to present each email message within interface 340 (or another interface linked to interface 340). Email messages 362 can correspond to one or more annotations 364, where zero or more annotations can exist for each email message 362. Each annotation 364 can have a link, where selection of the link causes the selected annotation 364 to be presented.

In one embodiment, the user interface 340 can include an option 352 to archive the annotations 364 and/or the email messages 362. Other options can include one to delete 354 the annotations (corresponding to option 156, for example) and an option 356 to delete the email messages and annotations (corresponding to option 157, for example).

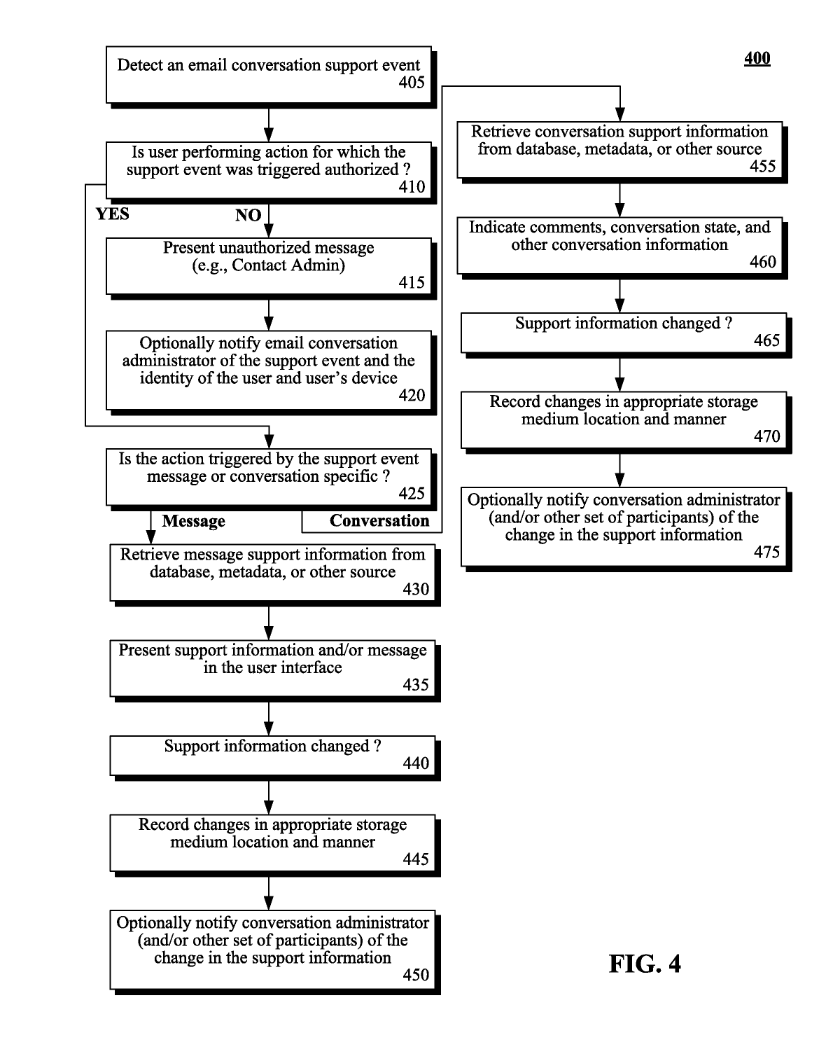

FIG. 4 is a flow chart of a method 400 for managing email conversations in accordance with an embodiment of the disclosure. In one embodiment, method 400 can be implemented using system 200 of FIG. 2.

The method 400 can begin in step 405 where an email conversation support event can be detected. The support event can be any event related to the annotating an email conversation, to viewing an email conversation annotations, to stopping or restarting an email conversation, to deleting or archiving email conversation support information, and the like. In step 410, a determination can be made as to whether a user is authorized to perform an action related to the support event. In one embodiment, only users on distribution list for the messages of the email conversation can view, edit, or modify support information associated with the email conversation. In another embodiment, a designated administrator (i.e., email conversation initiator by default in one embodiment) can set different permission levels for accessing and modifying the support information.

When the user lacks the required permission for the action, a message to this effect can be presented to the user, as shown by step 415. In one embodiment, a notification of the administrator to contact for permission can be presented as part of the message. In step 420, an administrator of the email conversation can be notified of the support event and the person/location that triggered the event. The notification of step 420 can be a means for identifying unapproved individuals who have been granted access to the email conversation. When used for security purposes, the message of step 415 may not be presented to the user.

When permissions exist to perform the action that corresponds to the support event, step 425 can execute. When the support event is for a specific message, support information for that email message can be retrieved, as shown by step 430. A message including at least a portion of the retrieved support information (or information derived or dependent upon the retrieved support information) can be presented in a user interface, as shown by step 435. The user may manipulate the support information using the interface. If support information changes (step 440), updated or new support information can be recorded in a suitable location, as shown by step 445. The storage location can be a database, metadata attached to the email message, and the like, depending on implementation choices. An email conversation administrator (or a defined set of email conversation participants) can be optionally notified of the change.

If the user has appropriate permissions and if the support action is one for the email conversation, the method can progress to step 455, where appropriate email conversation information can be retrieved given the support event and desired action. In step 460, the retrieved information (or information derived from or dependent upon retrieved information) can be presented to the user within a user interface. This information can include, but is not limited to, an email conversation state, a summary of the email conversation, annotations for the email conversation, and other information recorded for the email conversation. In one embodiment, the user can change the email conversation information or input new information. If this occurs, the changed or created information can be recorded in an appropriate manner (e.g., database storage, metadata storage, file-based storage, etc.), as shown by step 470. In step 475, an email administrator (or a defined set of email conversation participants) can be optionally notified of the change.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A system comprising:
an conversation support component comprising software stored on a storage medium where the software is able to be executed by a processor of a computing device, said conversation support component being operable to change a state of an email conversation, wherein said email conversation comprises a sequence of zero or more response email messages to an initial email message as well as the initial email message, wherein said state of the email conversation is able to be changed between open and closed, wherein when an email conversation is in an open state, participants of the email conversation are able to provide new email responses to email messages of the email conversation, wherein when the email conversation is in a closed state, participants of the email conversation are not permitted to provide new email responses to email messages of the email conversation.

2. The system of claim 1, wherein the conversation support component is a server-side component that communicates with an email server which manages the email messages of the email conversation, wherein incoming attempts to send messages sent to the email server from a client device are refused when the incoming attempt is a reply email to an email conversation in a closed state, wherein incoming attempts to send messages sent to the email server from the client are accepted by the email server and sent to designated recipients when the incoming attempt is not a reply email to an email conversation in a closed state.

3. The system of claim 1, further comprising:
a user interface for an email application comprising a user interface option to reply_to an email message and comprising a user interface option to reply^{—}to_all, wherein if an email message presented in the user interface is part of an email conversation that is in an open state then the reply_to and the reply_to_all options are enabled within the user interface, and wherein if the email message presented in the user interface is part of the email conversation that is in a closed state then the reply_to and the reply_to_all options are not enabled within the user interface.

4. The system of claim 1, further comprising:
a data store of an email server comprising a plurality of email messages managed by the email server, wherein the data store indexes email conversations to the email messages, wherein each of the email conversations comprises a plurality of data elements directly associated with a specific one of the email conversation and not directly associated with any specific email message, wherein the data elements comprise an indicator of the state of the corresponding email conversation.

5. The system of claim 4, wherein the data elements comprise at least one email conversation annotation, and at least one urgency level for the email conversation, wherein the urgency level indicates one of a plurality of different discrete values each indicative of a different level of urgency for the email conversation.

6. The system of claim 4, wherein at least one of the data elements indicates a user identity of an administrator of the corresponding email conversation, wherein the administrator is the only user permitted to change the state of the email conversation.

7. The system of claim 4, wherein a sender of the initial message is the only person authorized to change values of the data elements, wherein participants of the email conversation are permitted to view the values of the data elements input by the sender.

8. The system of claim 4, further comprising:
a plurality of annotations comprising user input content, where each of the plurality of annotations corresponds to one of the email messages of the email conversation, wherein the only users able to view the annotations are a user that created the corresponding annotation and a user that sent the initial message of the email conversation, wherein said user that sent the initial message of the email conversation is the administrator of the email conversation.

9. The system of claim 1, wherein the conversation support component comprises an archive function option for archiving email messages on an email conversation basis and comprises a delete conversation function for deleting email messages on an email conversation basis.

10. A system comprising:
an conversation support component comprising software stored on a storage medium where the software is able to be executed by a processor of a computing device, said conversation support component being operable to provide a plurality of email conversation management functions; and
a data store of an email server comprising a plurality of email messages managed by the email server, wherein the data store indexes email conversations to the email messages, wherein each of the email conversations comprises a plurality of data elements directly associated with a specific one of the email conversation and not directly associated with any specific email message, wherein at least one of the data elements indicates a user identity of an administrator of the corresponding email conversation, wherein the administrator is the only user permitted to change values of the data elements of the corresponding email conversation, which other participants of the email conversation are able to view but are unable to change.

11. The system of claim 10, wherein at least one of the data elements comprise an indicator of the state of the corresponding email conversation, wherein said state of the email conversation is able to be changed between open and closed, wherein when an email conversation is in an open state, participants of the email conversation are able to provide new email responses to email messages of the email conversation, wherein when the email conversation is in a closed state, participants of the email conversation are not permitted to provide new email responses to email messages of the email conversation.

12. The system of claim 10, wherein at least one of the data elements is an urgency level for the email conversation, wherein the urgency level indicates one of a plurality of different discrete values each indicative of a different level of urgency for the email conversation, wherein the administrator is the only user permitted to change values of the urgency level of the corresponding email conversation, which other participants of the email conversation are able to view but are unable to change.

13. The system of claim 10, wherein the administrator of an email conversation is a sender of the initial email message of the email conversation.

14. The system of claim 10, further comprising:
a plurality of annotations comprising user input content, where each of the plurality of annotations corresponds to one of the email messages of the email conversation, wherein the only users able to view the annotations are a user that created the corresponding annotation and the administrator of the email conversation.

15. The system of claim 10, wherein the conversation support component comprises:
a message annotator for creating annotations to the email messages of the email conversations and to the email conversations, wherein annotations to the email conversations do not directly correspond to any specific email message.

16. The system of claim 15, wherein the conversation support component comprises:
an archive function for archiving email messages on an email conversation basis, wherein selection of the archive function archives each email message of a specific one of the email conversations and archives each annotation that is associated with the specific one of the email conversations.

17. The system of claim 15, wherein the conversation support component comprises:
a delete function for deleting email messages on an email conversation basis, wherein selection of the delete function deletes each email message of a specific one of the email conversations and deletes each annotation that is associated with the specific one of the email conversations.

18. The system of claim 14, wherein the email conversation management functions comprise an annotate function, an end conversation function, a mark urgent function, a delete conversation function, and a re-open function.

19. A method comprising:
within an email server, establishing a state for an email conversation, wherein said email conversation comprises a sequence of zero or more response email messages to an initial email message as well as the initial email message, wherein said state of the email conversation is able to be changed between open and closed,
if the state of the email conversation is in an open state, allowing new response email messages to be created from a user interface of an email application for the email conversation, where said new response email messages are conveyed by the email server to a set of recipients indicated within each of the new response email messages; and
if the state of the email conversation is in a closed state, preventing users from creating new response email messages for the email conversation, where the preventing ensures that new response email messages for the email conversation are not conveyed by the email server to any recipient.

20. The method of claim 19, further comprising:
establishing a plurality of time-stamped annotations for the email conversation and for specific messages of the email conversation; and
responsive to a user of the user interface selecting one of the email messages via a hover event of a GUI pointer being triggered, automatically presenting the plurality of time-stamped annotations associated with that email message and the email conversation in a fly-over window of the user interface.
